(19) United States
(12) Patent Application Publication
(10) Pub. No.: US 2012/0052233 A1
(43) Pub. Date: Mar. 1, 2012

(54) INTERLOCKING SHEETS AND METHODS AND APPARATUS FOR MAKING SAME

(76) Inventor: Miroslav Planeta, Mississauga (CA)

(21) Appl. No.: 12/862,738

(22) Filed: Aug. 24, 2010

(51) Int. Cl. B32B 3/00; B29C 51/02

(52) U.S. Cl. 428/99; 264/289.3; 425/112

(57) ABSTRACT

An interlocking sheet is formed from a resilient, flexible material. The interlocking sheet comprises a plurality of regularly spaced locking members projecting from a first side of the sheet. Each locking member is hollow and an aperture on the second side of the sheet opens into the interior volume of the locking member. Each locking member has a proximal portion adjacent the aperture, a medial portion further from the aperture than the proximal portion, and a distal portion further from the aperture than the medial portion. The maximum width of the medial portion is greater than the narrowest width of the proximal portion, measured in a common direction, and each locking member tapers from the medial portion to the distal portion. The locking members may be elongate linear locking members or discrete legs. A method and apparatus for making the interlocking sheets are also described.

### FIELD OF INVENTION

The present invention relates to plastic sheet material, and more particularly to plastic sheets which can interlock with one another.

### BACKGROUND OF THE INVENTION

Extruded plastic sheets have a wide variety of practical applications. The effectiveness of such extruded sheets would be enhanced by the ability to releasably interlock the sheets with themselves and other similar sheets. U.S. Pat. No. 5,016,417 describes modular construction units employing a flexible web with interlockable heads, which provide some of these advantages, but which still have significant disadvantages.

### SUMMARY OF THE INVENTION

In one aspect, the present invention is directed to an interlocking sheet formed from a resilient material. The interlocking sheet comprises a plurality of regularly spaced locking members projecting from a first side of the sheet. Each locking member is hollow so as to define an interior volume thereof and has an aperture opening into the interior volume from a second side of the sheet. Each locking member has a proximal portion adjacent the aperture, a medial portion further from the aperture than the proximal portion, and a distal portion further from the aperture than the medial portion. The widest width of the medial portion is greater than the narrowest width of the proximal portion, measured in a common direction. Each locking member tapers from the medial portion to the distal portion. The common direction may be parallel to a notional plane defined by the aperture. In one embodiment, the aperture and the interior volume of each locking member cooperate to define a receptacle for another correspondingly-shaped locking member.

In one embodiment, the locking members also project from a second side of the sheet.

In one embodiment, each locking member tapers at a constant slope from the medial portion to the distal portion, and in another embodiment, each locking member tapers at a variable slope from the medial portion to the distal portion.

In one embodiment, each locking member further comprises a terminal nub further from the aperture than the distal portion.

In one embodiment, each locking member tapers at a constant slope from the medial portion to the proximal portion, and in another embodiment, each locking member tapers at a variable slope from the medial portion to the proximal portion.

In one embodiment, there is an abrupt discontinuity in width between the proximal portion and the medial portion.

The locking members may be elongate linear locking members that extend across the sheet parallel to one another, or may be discrete regularly spaced legs having a defined outer perimeter at the medial width. In the latter embodiment, the legs may have a circular outer perimeter at the medial width.

In another aspect, the present invention is directed to a method of forming an interlocking sheet. The method comprises the steps of extruding a web from an extruder, guiding the web while still semi-molten to a vacuum forming roller that has an outer surface including a plurality of regularly spaced projections, and applying a vacuum to the forming roller while the web is in contact with the outer surface thereof so that the web acquires locking members corresponding in size, shape and position to the projections on the forming roller to become an interlocking sheet. The projections on the forming roller have a proximal portion, a medial portion further from the axis of rotation of the forming roller than the proximal portion, and a distal portion further from the axis of rotation of forming roller than the medial portion. The widest width of the medial portion is greater than the narrowest width of the proximal portion, measured in a common direction tangential to the forming roller, and the projections on the forming roller taper from the medial portion to the distal portion. The forming roller has vacuum apertures defined in its outer surface at least in the proximal portions of the projections. The forming roller may be actively cooled to cool the web.

In one embodiment, the projections are elongate linear projections and extend across a width of the vacuum forming roller, parallel to an axis of rotation thereof, resulting in an interlocking sheet in which elongate linear locking members extend across the sheet parallel to one another. The method may further comprise removing the interlocking sheet from the forming roller and rolling the interlocking sheet into a roll in which the elongate linear locking members extend parallel to a central axis of the roll. In such an embodiment, rolling the interlocking sheet into a roll preferably comprises rolling the interlocking sheet into a roll in which the locking members of inner layers of the roll are nested inside respective locking members of adjacent outer layers of the roll.

In a further aspect, the present invention is directed to apparatus for forming an interlocking sheet. The apparatus comprises a forming roller having an outer surface including a plurality of regularly spaced projections. The projections on the forming roller have a proximal portion, a medial portion further from the axis of rotation of the forming roller than the proximal portion, and a distal portion further from the axis of rotation of the forming roller than the medial portion. The widest width of the medial portion is greater than the narrowest width of the proximal portion, measured in a common direction tangential to the forming roller. The projections on the forming roller taper from the medial portion to the distal portion. The forming roller is a vacuum forming roller having vacuum apertures defined in the outer surface thereof at least in the proximal portions of the projections.

The apparatus preferably further comprises an extruder for extruding a web and a guide mechanism for guiding the web into engagement with the outer surface of the vacuum forming roller, and also preferably further comprises a winding mechanism for removing the web from the vacuum forming roller and winding the web into a roll.

### BRIEF DESCRIPTION OF THE DRAWINGS

These and other features of the invention will become more apparent from the following description in which reference is made to the appended drawings wherein:

FIG. 1 is a perspective view showing a first exemplary embodiment of an interlocking sheet according to an aspect of the present invention being extruded from an extruder;

FIG. 2 is a side view of a first exemplary embodiment of the interlocking sheet of FIG. 1;

FIGS. 2A to 2C are side views showing two of the interlocking sheets of FIG. 1 being interlocked with one another;

FIGS. 2D to 2F are perspective views showing two of the interlocking sheets of FIG. 1 being interlocked with one another;

FIG. 3 is a detailed side view of a locking member of the interlocking sheet of FIG. 1;

FIG. 3A is an end view of the interlocking sheet of FIG. 1;

FIG. 3B is a perspective view of a portion of the interlocking sheet of FIG. 1;

FIGS. 4A and 4B are side views showing the interlocking sheet of FIG. 1 laminated to a generally planar sheet;

FIG. 5 is a side view of two of the interlocking sheets of FIG. 1 laminated to each other;

FIGS. 6 and 6A are end views of a roll formed from the interlocking sheet of FIG. 1;

FIG. 6B is an end view of the interlocking sheet of FIG. 1 secured to the roll of FIGS. 6A and 6B;

FIG. 6C is a perspective view of the interlocking sheet of FIG. 1 secured to the roll of FIGS. 6A and 6B;

FIG. 6D is a perspective view of a structure formed from a plurality of the rolls of FIGS. 6A and 6B and one or more interlocking sheets of FIG. 1;

FIG. 6E is a detailed top view of a portion of the structure of FIG. 6D showing attachment of one of the interlocking sheets to one of the rolls serving as an intermediate post;

FIG. 6F is a detailed top view of a portion of the structure of FIG. 6D showing attachment of one of the interlocking sheets to one of the rolls serving as a corner post;

FIGS. 7 and 7A are perspective views of a portion of the roll of FIGS. 6A and 6B;

FIG. 8A is a schematic representation of an apparatus according to an aspect of the present invention;

FIG. 8B is a detailed cross-sectional view of a portion of a vacuum forming roller that is part of the apparatus of FIG. 8A;

FIG. 9 is a perspective view of an interlocking sheet formed by the apparatus of FIG. 8A and having arbitrary length L;

FIG. 10 is an end view of two instances of a second exemplary embodiment of an interlocking sheet, according to an aspect of the present invention;

FIG. 10A is a detailed end view of a portion of one of the interlocking sheets of FIG. 10;

FIG. 11 is an end view of the two instances of the interlocking sheet of FIG. 10, interlocked with one another;

FIG. 12 is a side view showing the interlocking sheet of FIG. 10 laminated to a flat sheet;

FIG. 13 shows two sheets according to FIG. 12 interlocked with one another;

FIG. 14 is a detailed end view of a portion of a third exemplary embodiment of an interlocking sheet, according to an aspect of the present invention;

FIG. 15 shows an end view of portions of two instances of the interlocking sheets of FIG. 14, positioned to be interlocked with one another;

FIG. 16 is a detailed end view of a portion of a fourth exemplary embodiment of an interlocking sheet, according to an aspect of the present invention;

FIG. 17 shows an end view of portions of two instances of the interlocking sheets of FIG. 16, interlocked with one another;

FIG. 18A is a detailed end view of portions of two instances of a fifth exemplary embodiment of an interlocking sheet, according to an aspect of the present invention;

FIG. 18B shows portions of the interlocking sheets of FIG. 18A interlocked with one another;

FIG. 19A is a detailed cross-sectional view of a portion of a sixth exemplary embodiment of an interlocking sheet, according to an aspect of the present invention;

FIG. 19B is a perspective view of a portion of the interlocking sheet of FIG. 19A;

FIG. 19C shows a cross-sectional view of two instances of the interlocking sheet of FIG. 19A, positioned to be interlocked with one another;

FIG. 20A is a top view of a portion of a seventh exemplary embodiment of an interlocking sheet, according to an aspect of the present invention;

FIG. 20B is a perspective view of a portion of the interlocking sheet of FIG. 20A;

FIG. 20C shows a cross-sectional view of two instances of the interlocking sheet of FIG. 20A, positioned to be interlocked with one another;

FIG. 21A is a top view of a first interlocking sheet according to an eighth exemplary embodiment, according to an aspect of the present invention;

FIG. 21B is a top view of a second interlocking sheet according to an eighth exemplary embodiment, according to an aspect of the present invention;

FIG. 21C is a top view showing the interlocking sheets of FIGS. 21A and 21B interlocked with one another; and

FIG. 21D is a cross-sectional view showing the interlocking sheets of FIGS. 21A and 21B interlocked with one another.

### DETAILED DESCRIPTION

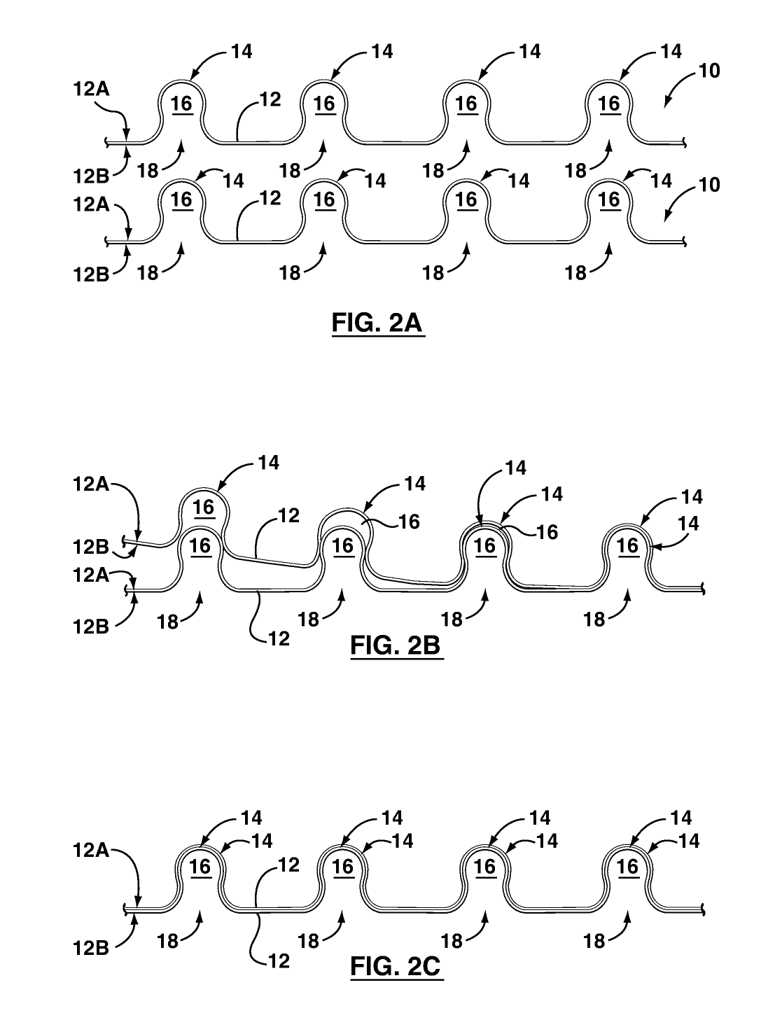

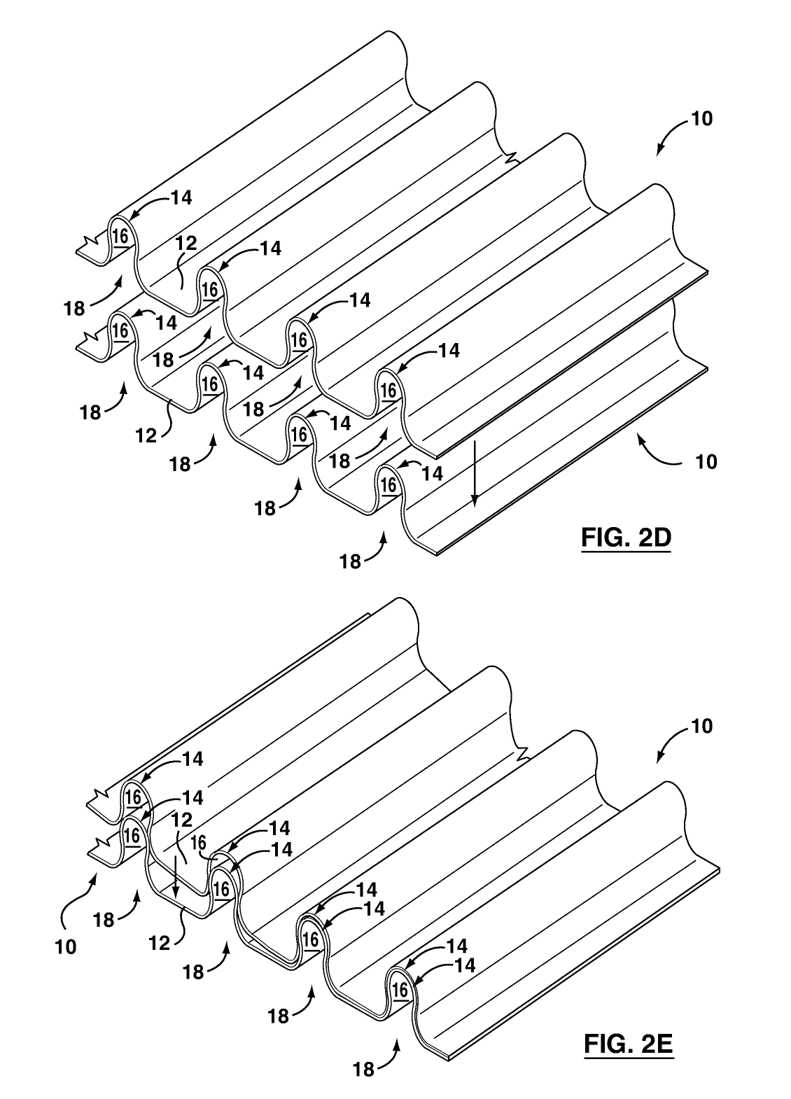

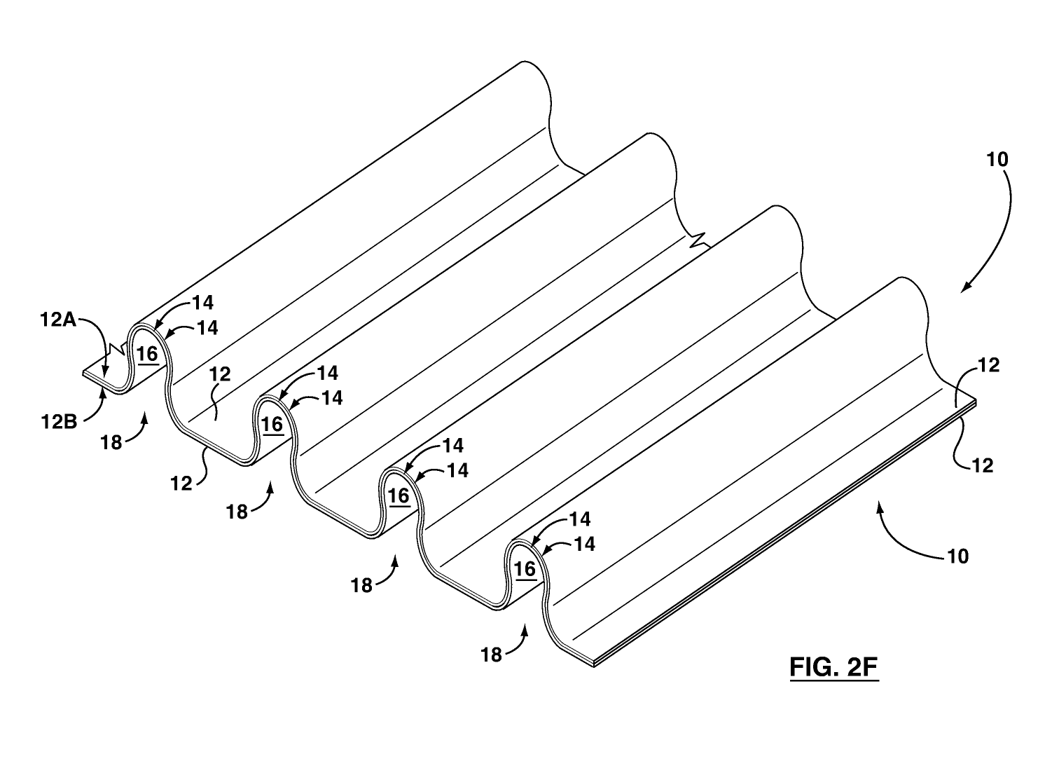

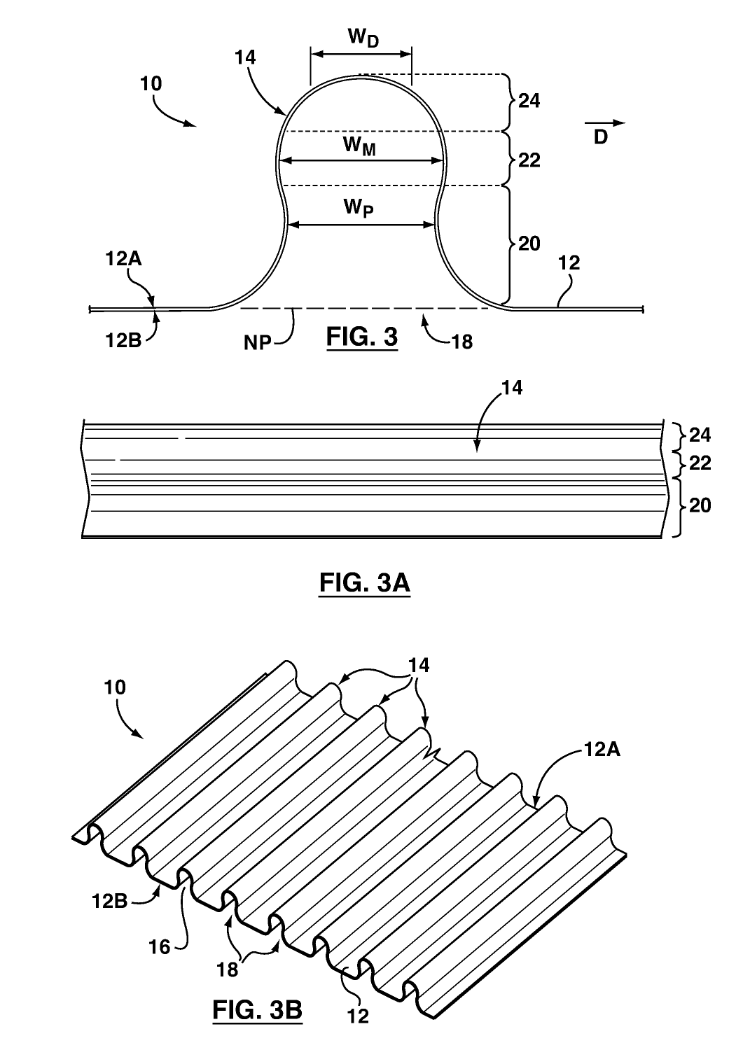

A first embodiment of an exemplary interlocking sheet according to an aspect of the present invention is shown in FIGS. 2 to 3B and is indicated generally by the reference numeral 10. The interlocking sheet 10 is formed from a resilient, flexible material such as a suitable plastic.

Reference is first made to FIGS. 3A and 3B, which are an end view and a perspective view, respectively, of the exemplary interlocking sheet 10. The interlocking sheet 10 comprises a plurality of regularly spaced locking members 14 projecting from a first side 12A of the interlocking sheet 10. As best seen in FIG. 3B, in the embodiment shown in FIGS. 2 to 3B, the locking members 14 are elongate linear locking members and extend across the sheet parallel to one another, with the interlocking sheet 10, including the locking members 14, being formed from a single sheet of plastic. Methods of forming interlocking sheets such as the interlocking sheet 10 will be described below.

Referring now to FIG. 2, it can be seen that each locking member 14 is hollow so as to define an interior volume 16 thereof, and each locking member 14 has an aperture 18 defined on the second side 12B of the interlocking sheet 10, opposite the first side 12A. The aperture 18 opens into the interior volume 16 of the respective locking member 14. As shown in FIGS. 2A to 2F, two identical interlocking sheets 10 can be interlocked with one another by inserting the locking members 14 of one of the interlocking sheets 10 into the correspondingly positioned apertures 18 of the other interlocking sheet 10, so that the locking members 14 of the one interlocking sheet 10 are received inside the interior volume 16 of the locking members 14 of the other interlocking sheet 10. Thus, the aperture 18 and interior volume 16 cooperate to define a receptacle for a correspondingly-spaced locking member 14.

With reference now to FIG. 3, it can be seen that the locking members 14 are generally pyriform in cross-section and have a shape approximating that of a rowlock arch. Each locking member 14 has, measured in a common direction D, a proximal portion 20, a medial portion 22, and a distal portion 24. As can be seen, the proximal portion 20 is disposed adjacent the aperture 18, the medial portion 22 is further from the aperture 18 than the proximal portion 20, and the distal portion 24 is further from the aperture 18 than the medial portion 22. The common direction D may be defined as being parallel to a flat portion 12 of the interlocking sheet 10, or as being parallel to a notional plane NP defined by the aperture 18.

Continuing to refer to FIG. 3, the widest width W_{M} of the medial portion 22 is greater than the narrowest width W_{P} of the proximal portion 20, measured in the common direction D. The width W_{D} of the distal portion 24 as measured in the common direction D will, at any given point on the distal portion 24, be less than the widest width W_{M} of the medial portion 22. The locking member 14 tapers smoothly from the medial portion 22 to the distal portion 24, and, in the particular embodiment shown in FIGS. 2 to 3B, the locking member 14 curves inwardly from the medial portion 22 and along the distal portion 24 toward the distal end thereof, and therefore tapers at a variable slope from the medial portion 22 to the distal portion 24. Similarly, in the embodiment shown in FIGS. 2 to 3B, each locking member 14 is curved inwardly at the proximal portion 20, and therefore tapers at a variable slope from the medial portion 22 to the proximal portion 20.

The smooth taper from the medial portion 22 to the distal portion 24 assists in guiding the distal portion 24 and the medial portion 22 of the locking members 14 on the first interlocking sheet 10 into the apertures 18 on the second interlocking sheet 10 and past the proximal portions 20 of the locking members 14 on the second interlocking sheet 10. As noted above, the widest width W_{M} of the medial portion 22 is greater than the narrowest width W_{P} of the proximal portion 20. As a result, when inserting the locking members 14 of a first interlocking sheet 10 into the locking members 14 of a second interlocking sheet 10, as shown in FIGS. 2A to 2F, the medial portions 22 of the locking members 14 on the first interlocking sheet 10 will force the walls of the proximal portions 20 of the locking members 14 on the second interlocking sheet 10 to flex outwardly, away from one another, or the proximal portions 20 of the locking members 14 on the second interlocking sheet 10 will force the walls of the medial portions 22 of the locking members 14 of the first interlocking sheet 10 to flex inwardly, toward one another, or both. This allows the medial portions 22 of the locking members 14 on the first interlocking sheet 10 to move past the proximal portions 20 of the locking members 14 on the second interlocking sheet 10 so that the locking members 14 on the first interlocking sheet 10 are fully nested inside the interior volume 16 of the locking members 14 on the second interlocking sheet 10. Once the locking members 14 are nested one inside the other, the resilient nature of the material, coupled with the fact that the widest width W_{M} of the medial portion 22 is greater than the narrowest width W_{P} of the proximal portion 20, will cause the locking members to remain so nested until a suitable separation force is applied.

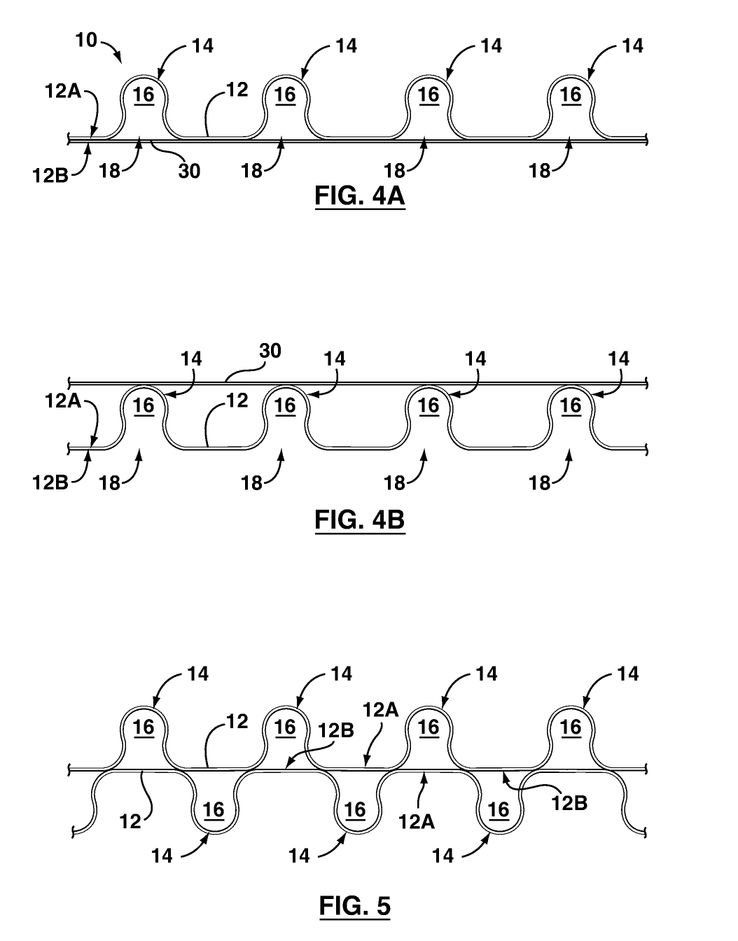

Interlocking sheets such as the interlocking sheets 10 may be used alone, or may be laminated to other sheets, such as the planar sheet 30, as shown in FIGS. 4A and 4B. As shown, where the locking members project from only one side of the interlocking sheet, as with the locking members 14 on the interlocking sheet 10, the planar sheet 30 may be laminated to either the first side 12A (FIG. 4B), or the second side 12B (FIG. 4A) of the interlocking sheet 10, depending on the desired application. The sheets 10, 30 may be laminated to each other by any suitable technique. For example, the planar sheet 30 may be a tile, and interlocking sheets according to aspects of the present invention may, when sufficiently rigid, be used to securely but removably mount tiles to a surface, such as a floor, wall or ceiling.

Two interlocking sheets 10 may be laminated to each other with the locking members 14 of each sheet 10 arranged in staggered relation with the locking members 14 of the other sheet 10 and projecting in opposite directions, as shown in FIG. 5, again using any suitable laminating technique.

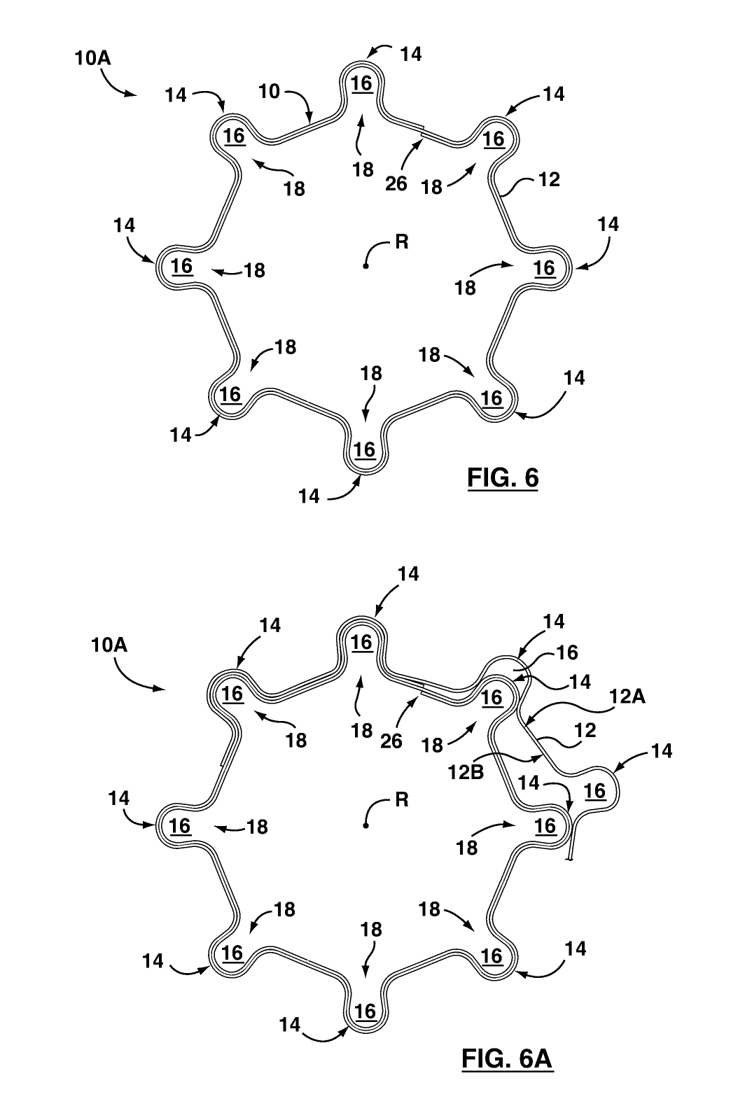

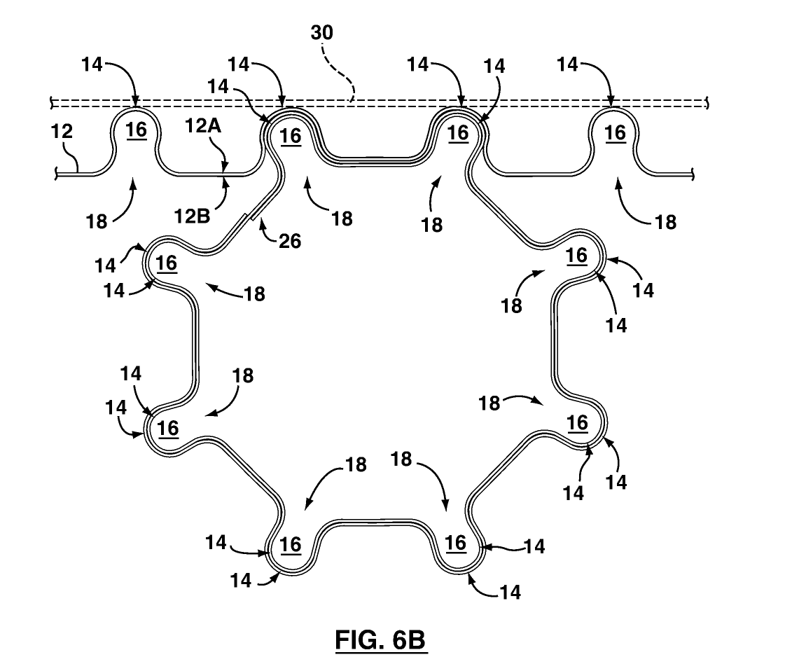

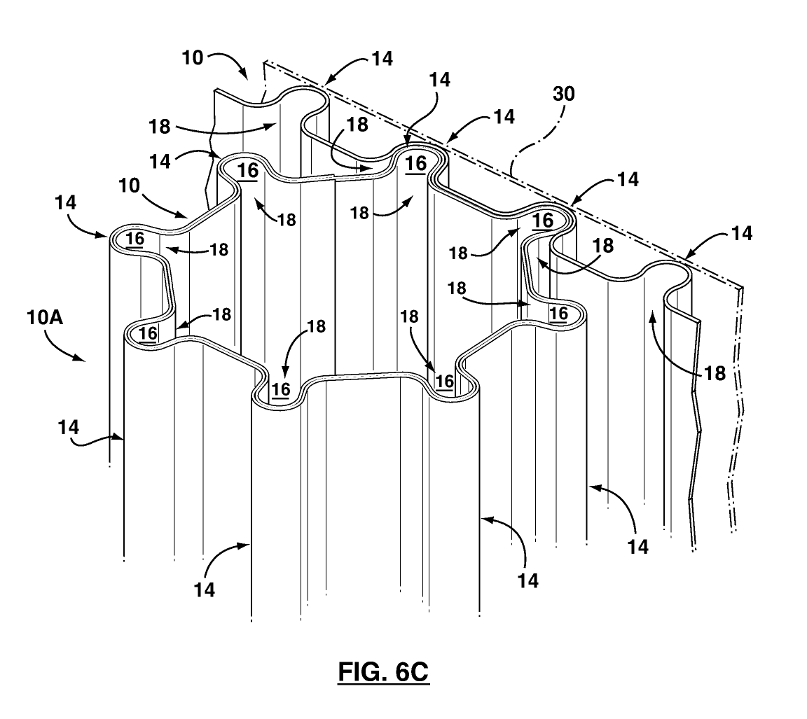

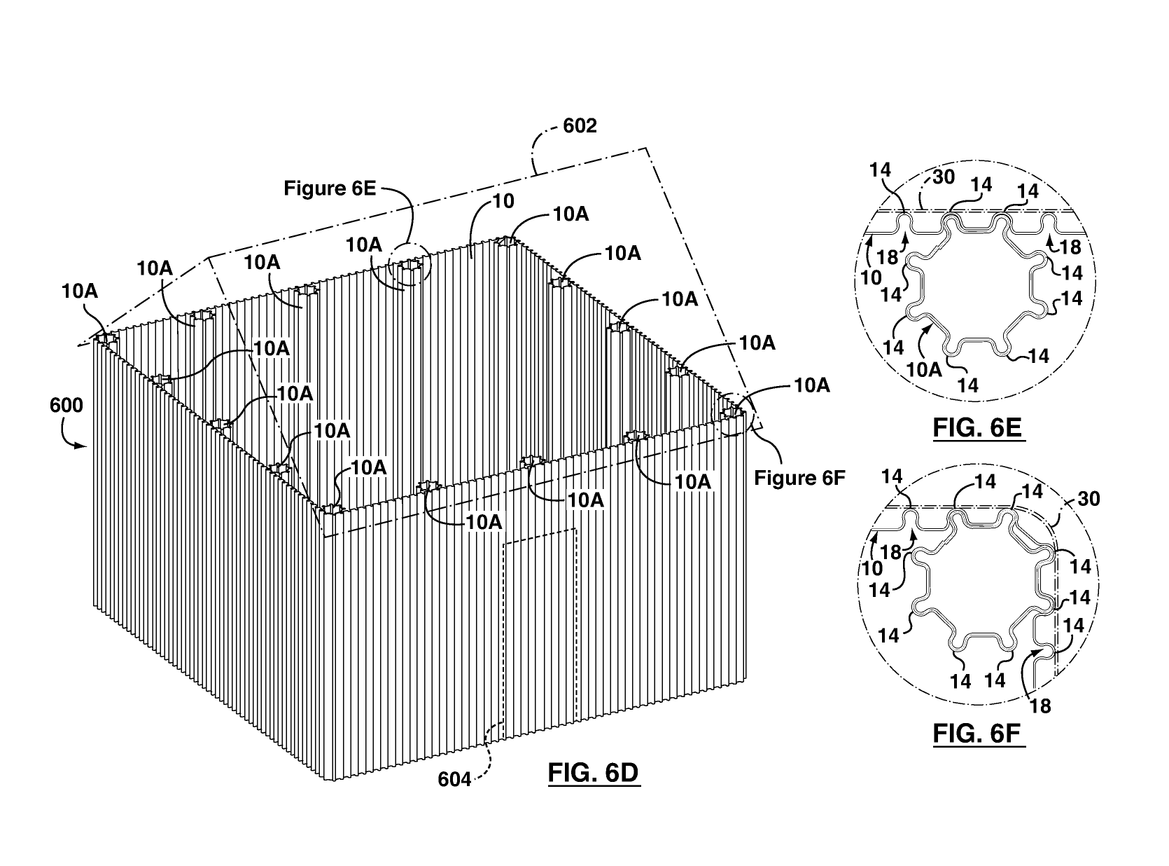

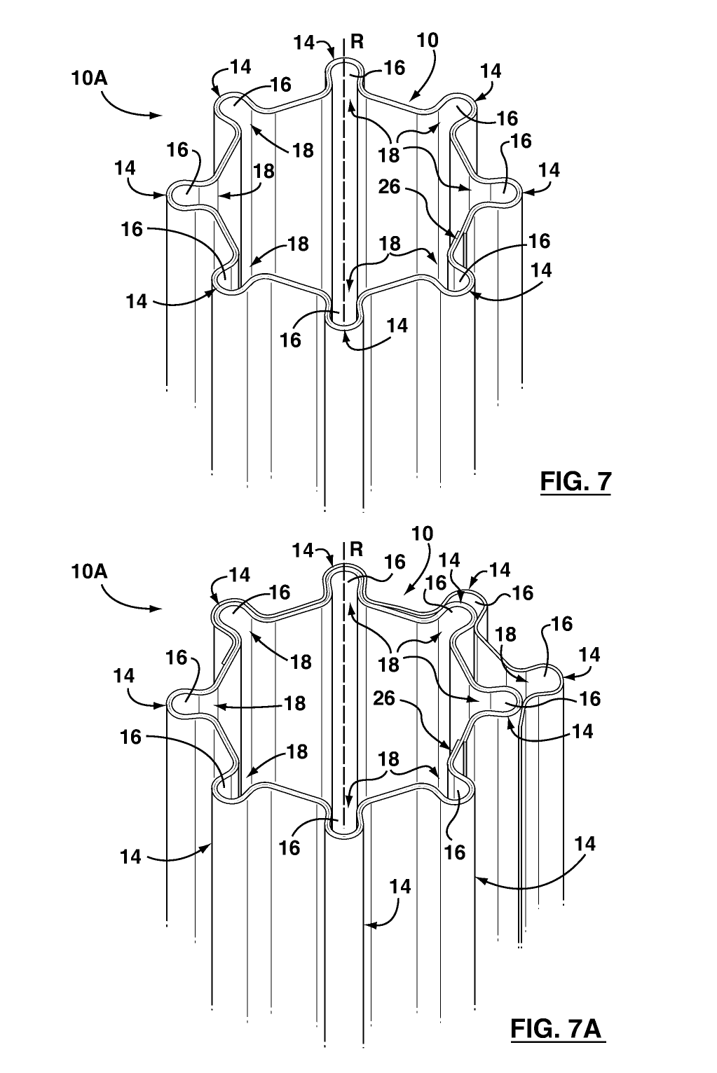

As shown in FIGS. 6, 6A, 7 and 7A, a single interlocking sheet 10 can be interlocked with itself in the form of a hollow roll or tube 10A. To achieve this structure, the sheet 10 is rolled about an axis R extending parallel to the longitudinal direction in which the locking members 14 extend until a first end 26 of the sheet 10 is in overlapping, adjacent relationship with another part of the sheet 10, at which point the locking members 14 of the underlying portion of the sheet 10 are inserted the correspondingly positioned apertures 18 of the overlying portion of the interlocking sheet 10. The rolling process is then continued so that for each inner layer of the roll 10A formed by the interlocking sheet 10, the locking members 14 are received inside the interior volume 16 of the locking members 14 of the outwardly adjacent layer.

Depending on the type of material used for the interlocking sheet, the tightness of the roll and the number of layers in the roll, rolls formed from an interlocking sheet by the above-described technique, such as the roll 10A formed from the interlocking sheet 10, can be sufficiently rigid to serve as support elements for lightweight, temporary structures formed wholly or partially from those interlocking sheets. For example, as shown in FIGS. 6B and 6C, an interlocking sheet such as the interlocking sheet 10 may be secured to a roll such as the roll 10A by inserting the outwardly protruding locking members 14 of the roll 10A into the apertures 18 and interior volumes 16 of the interlocking sheet 10 so that the interlocking sheet 10 is retained by the roll 10A. The interlocking sheet 10 may optionally have a planar sheet 30 laminated thereto to serve as an outer wall and provide additional rigidity.

An exemplary four-wall structure 600 is shown in FIG. 6D, in which a plurality of rolls 10A as described above serve as pillars and one or more interlocking sheets 10 serve as walls. The rolls 10A may be embedded in the ground, or secured to any suitable support structure. As shown in FIG. 6D, a single interlocking sheet 10 may be used to form all four walls by circumscribing the entire outer boundary defined by the rolls 10A, with one end of the interlocking sheet 10 overlapping the other end of the interlocking sheet 10 and secured thereto by way of the locking members 14 of one end of the interlocking sheet 10 being received in the correspondingly positioned apertures 18 and interior volumes 16 at the other end of the interlocking sheet 10. Alternatively, more than one interlocking sheet 10 may be used, for example with overlapping ends and the locking members 14 at the end of one interlocking sheet 10 being received in the correspondingly positioned apertures 18 and interior volumes 16 of an adjacent interlocking sheet 10. The structure 600 may optionally include a roof 602, which may be made from interlocking sheets such as the interlocking sheets 10 (not shown), with additional rolls such as the rolls 10A serving as roof supports (not shown), and which may be secured to the rolls 10A serving as pillars by any suitable means. Walls formed by the interlocking sheets 10 may optionally include one or more cut-outs, such as a door cut-out 604. FIG. 6E shows an interlocking sheet 10 secured to a roll 10A serving as an intermediate pillar, and FIG. 6F shows an interlocking sheet 10 secured to a roll 10A serving as a corner pillar.

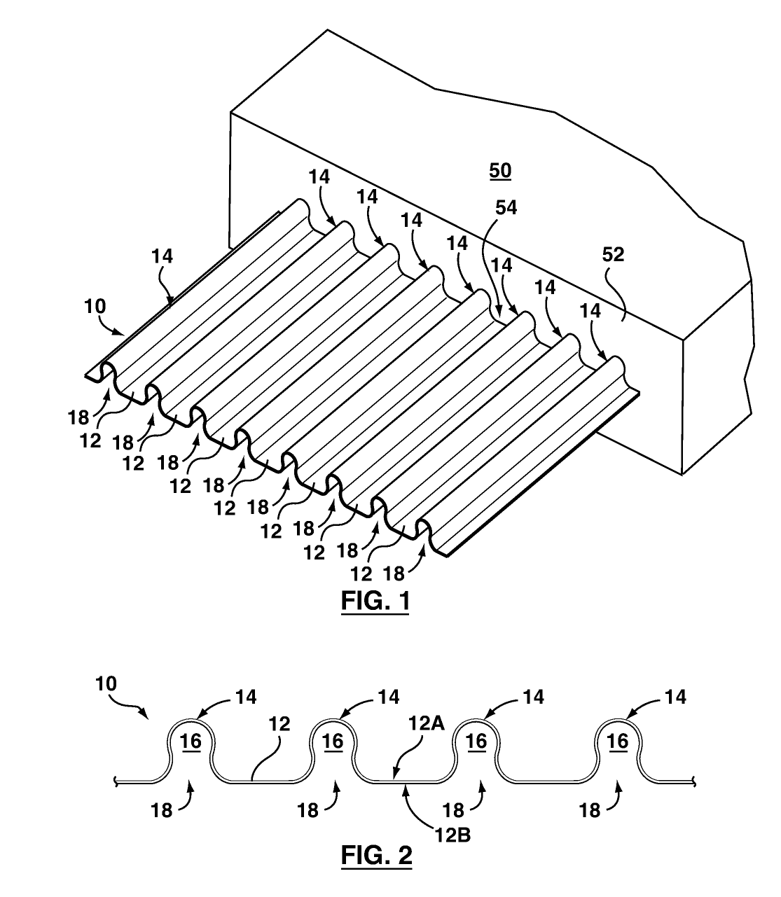

The exemplary interlocking sheets 10 described above in respect of FIGS. 1 through 7A have included a flat portion 12 disposed between adjacent locking members 14, and the locking members 14 projected from only one side 12A of the interlocking sheet 10. In other embodiments, interlocking sheets may include locking members that project from both sides of the sheet.

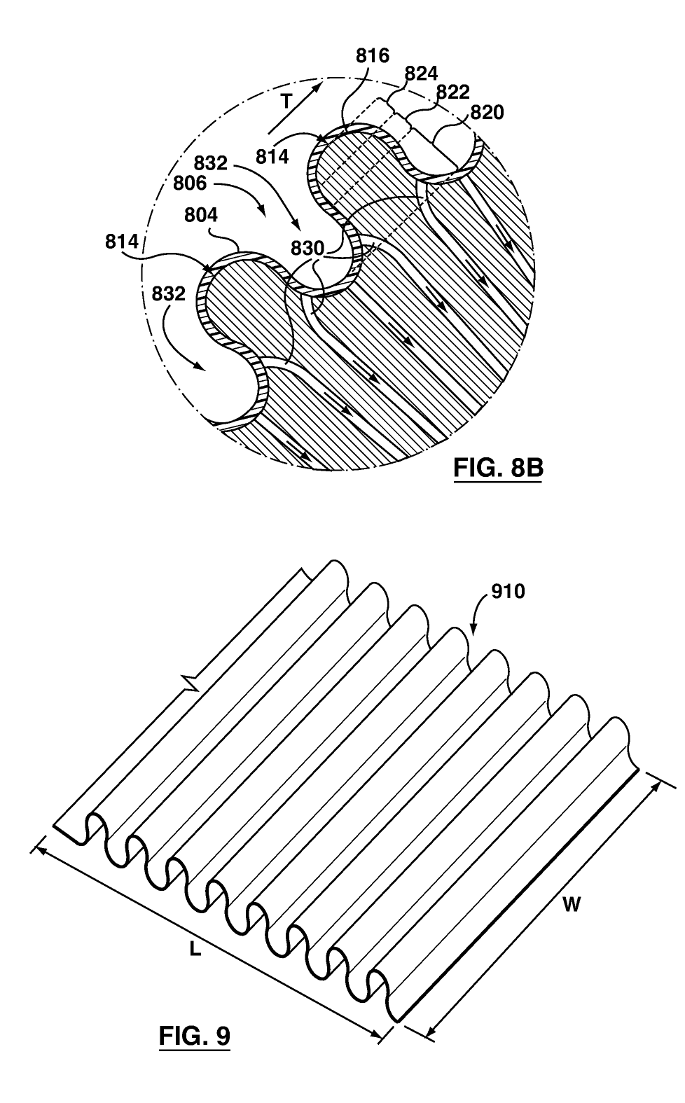

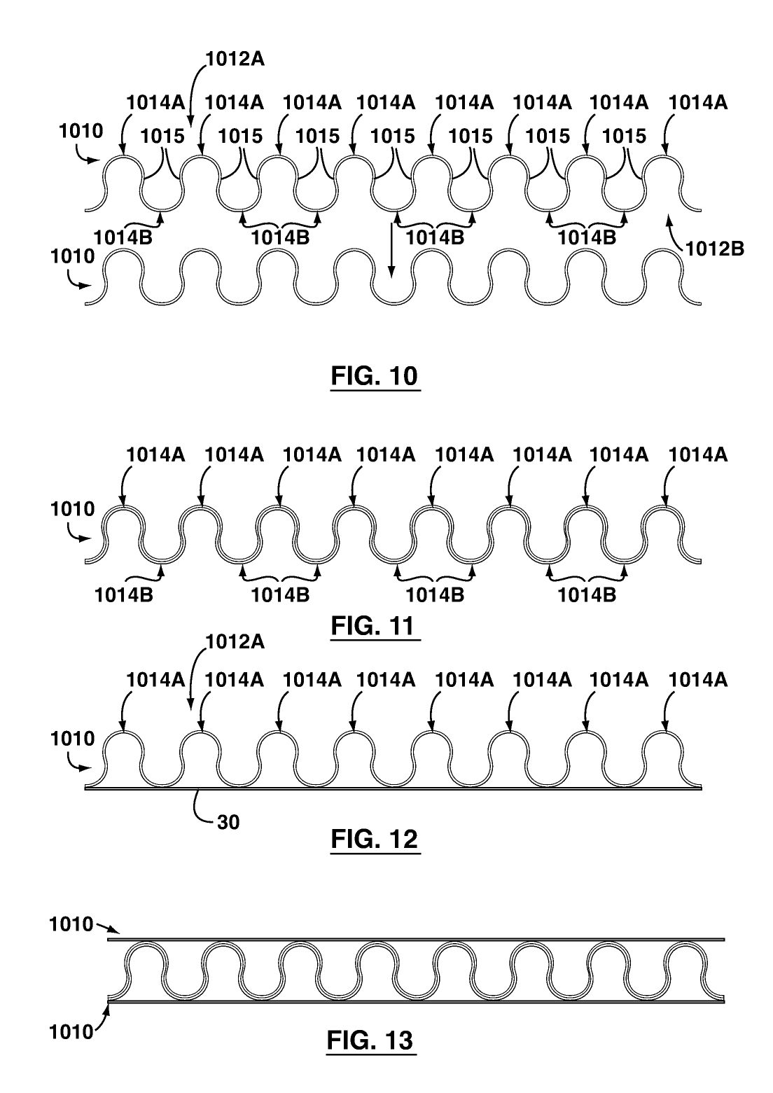

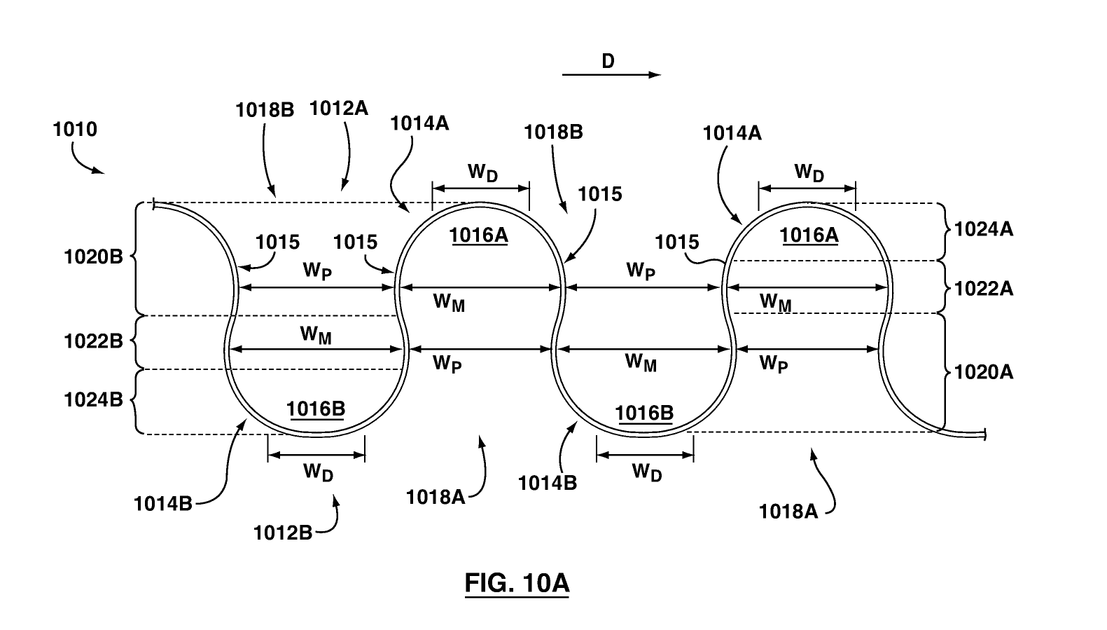

FIGS. 10 and 11 show a pair of exemplary interlocking sheets, each of which is indicated generally by the reference 1010. The interlocking sheets are formed from a resilient, flexible material, and comprise a first plurality of regularly spaced locking members 1014A projecting from a first side 1012A of the sheet 1010, and a second plurality of regularly spaced locking members 1014B projecting from a second side 1012B of the sheet 1010. The locking members 1014A, 1014B are elongate linear locking members formed by the undulating shape of the sheet 1010, and share side walls 1015 with one another. In particular, the side walls 1015 of each locking member 1014A projecting from the first side 1012A of the sheet are also the side walls 1015 of the two adjacent locking members 1014B projecting from the second side 1012B, and vice versa.

As shown in detail in FIG. 10A, each locking member 1014A, 1014B is hollow and defines a respective interior volume 1016A, 1016B and has a respective aperture 1018A, 1018B opening into the interior volume 1016A, 1016B from the other side 1012B, 1012A of the sheet 1010 to define a receptacle for a corresponding locking member. Each locking member 1014A, 1014B has, measured in a common direction D, a proximal portion 1020A, 1020B adjacent the respective aperture 1018A, 1018B, a medial portion 1022A, 1022B further from the respective aperture 1018A, 1018B than the proximal portion 1020A, 1020B, and a distal portion 1024A, 1024B further from the respective aperture 1018A, 1018B than the medial portion 1022A, 1022B. As was the case with the interlocking sheet 10 described above, for each locking member 1014A, 1014B, the widest width W_{M} of the respective medial portion 1022A, 1022B is greater than the narrowest width W_{P} of the respective proximal portion 1020A, 1020B, measured in the common direction D. Similarly, the width W_{D} of the distal portion 1024A, 1024B as measured in the common direction D will, at any given point on that distal portion 1024A, 1024B, be less than the widest width W_{M} of the medial portion 1022A, 1022B. Each locking member 1014A, 1014B tapers smoothly from the medial portion 1022A, 1022B to the distal portion 1024A, 1024B, and from the medial portion 1022A, 1022B to the proximal portion 1020A, 1020B.

As shown in FIGS. 10 and 11, two identical interlocking sheets 1010 can be interlocked with one another by inserting the locking members 1014A of a first interlocking sheet 1010 into the receptacles defined by the correspondingly positioned apertures 1018A and interior volumes 1016A of a second interlocking sheet 1010 while simultaneously inserting the locking members 1014B of the second interlocking sheet 1010 into the correspondingly positioned apertures 1018B of the first second interlocking sheet 1010, or vice versa. Thus, as shown in FIG. 11, the locking members 1014A, 1014B on one side of each sheet are received inside the interior volume 1016A, 1016B of the corresponding locking members 1014A, 1014B of the other interlocking sheet 1010. The interlocking sheets 1010 can be formed into rolls using the process described above, and can also be used to form lightweight structures, again as described above.

As shown in FIG. 12, a generally planar sheet 30 may be laminated to one side of the interlocking sheet 1010, in which case only the locking members on one side of the sheet (e.g. locking members 1014A on the first side 1012A) will be operative, since the locking members on the other side are obstructed by the planar sheet 30. Two such interlocking sheets 1010 may be interlocked with one another in the manner described above, as shown in FIG. 13.

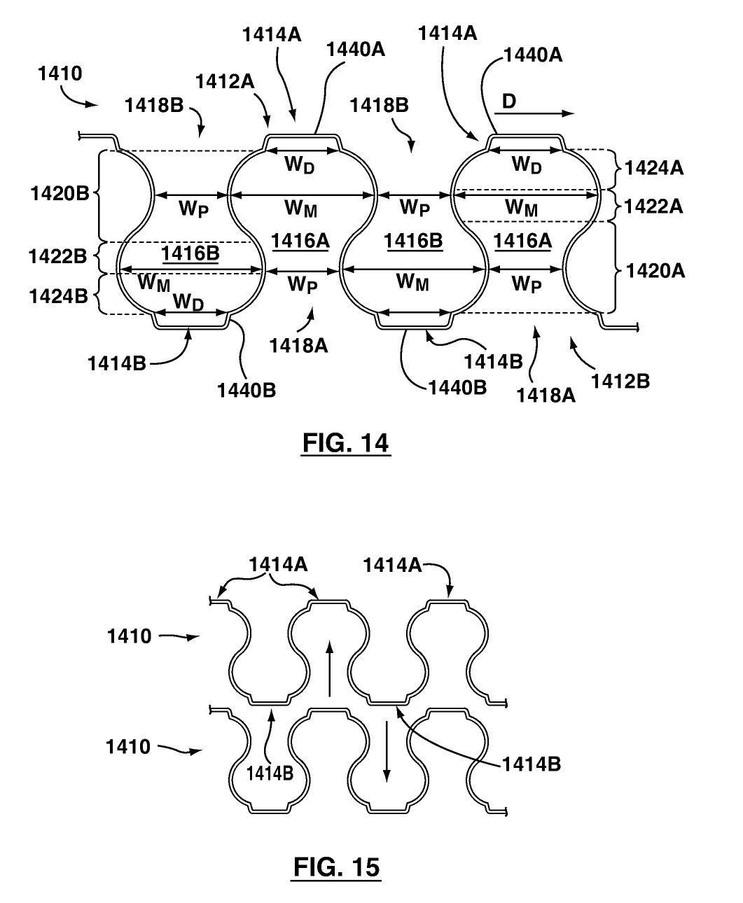

FIGS. 14 and 15 show interlocking sheets 1410 which are similar in construction to the interlocking sheets 1010 shown in FIGS. 10, 10A and 11, and corresponding reference numerals are used to denote corresponding elements, except with the prefix “14” instead of “10”. The interlocking sheets 1410 are formed from a resilient, flexible material, and comprise first and second pluralities of regularly spaced elongate linear hollow locking members 1414A, 1414B formed by the undulating shape of the sheet 1410, having shared walls and projecting from respective first and second sides 1412A, 1412B of the sheet 1410. A respective aperture 1418A, 1418B opens into the interior volume 1416A, 1416B of each locking member 1414A, 1414B from the other side 1412B, 1412A of the sheet 1410.

Each locking member 1414A, 1414B has a proximal portion 1420A, 1420B adjacent the respective aperture 1418A, 1418B, a medial portion 1422A, 1422B further from the respective aperture 1418A, 1418B than the proximal portion 1420A, 1420B, and a distal portion 1424A, 1424B further from the respective aperture 1418A, 1418B than the medial portion 1422A, 1422B. For each locking member 1414A, 1414B, as measured in the common direction D, the widest width W_{M} of the respective medial portion 1422A, 1422B is greater than the narrowest width W_{P} of the respective proximal portion 1420A, 1420B, and the width W_{D} of the distal portion 1424A, 1424B will, at any given point on that distal portion 1424A, 1424B, be less than the widest width W_{M} of the medial portion 1422A, 1422B. Each locking member 1414A, 1414B tapers smoothly from the medial portion 1422A, 1422B to the proximal portion 1420A, 1420B and the distal portion 1424A, 1424B, and also includes a terminal nub 1440A, 1440B further from the aperture 1418A, 1418B than the distal portion 1424A, 1424B and extending therefrom. Two of the interlocking sheets 1410 may be interlocked with one another in a manner analogous to that described above in respect of the interlocking sheets 1010, as shown in FIG. 15, and the interlocking sheets 1410 can be formed into rolls and used to form lightweight structures as described above.

As noted above, in the particular illustrated embodiments described above, the locking members 14, 1014A, 1014B, 1414A, 1414B are curved between the respective medial portion 22, 1022A, 1022B, 1422A, 1422B and the respective distal portion 24, 1024A, 1024B, 1424A, 1424B and therefore taper at a variable slope from the respective medial portion 22, 1022A, 1022B, 1422A, 1422B to the respective distal portion 24, 1024A, 1024B, 1424A, 1424B. The locking members 14, 1014A, 1014B, 1414A, 1414B are also curved between the respective proximal portion 20, 1020A, 1020B, 1420A, 1420B and the respective medial portion 22, 1022A, 1022B, 1422A, 1422B, and therefore taper at a variable slope from the respective medial portion 22, 1022A, 1022B, 1422A, 1422B to the respective proximal portion 20, 1020A, 1020B, 1420A, 1420B.

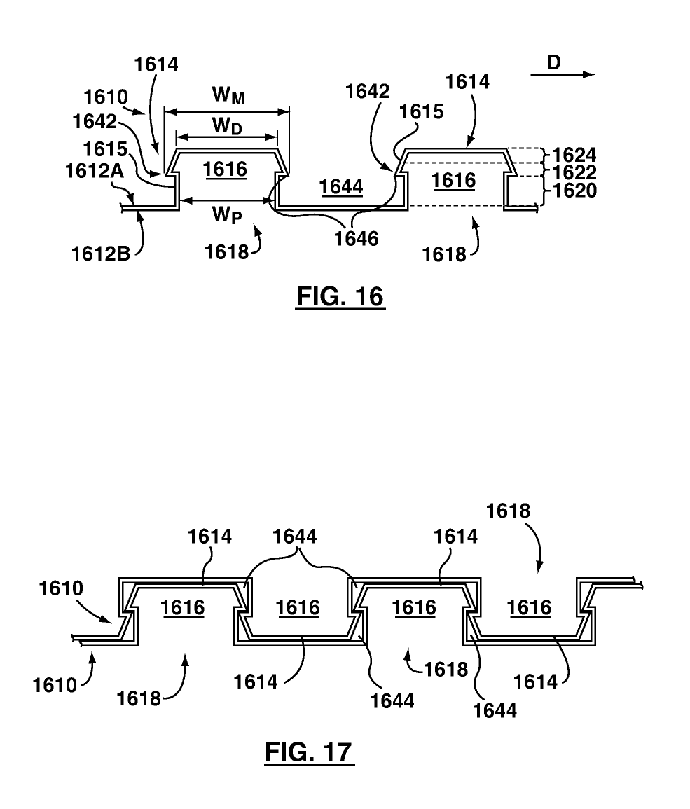

FIGS. 16 and 17 show interlocking sheets 1610 of resilient material in which the side walls 1615 are straight rather than continuously curving. Each interlocking sheet 1610 comprises a plurality of regularly spaced hollow elongate linear locking members 1614 projecting from a first side 1612A of the interlocking sheet 1610, with an aperture 1618 on the second side 1612B of the interlocking sheet 1610 opening into an interior volume 1616 of the locking member 1614. Each locking member 1614 has a proximal portion 1620 adjacent the aperture 1618, a medial portion 1622 further from the aperture 1618 than the proximal portion 1620 and a distal portion 1624 further from the aperture 1618 than the medial portion 1622. Rather than tapering, there is an abrupt discontinuity in width 1642 between the proximal portion 1620 and the medial portion 1622, and each locking member 1614 tapers at a constant slope from the medial portion 1622 to the distal portion 1624. For each locking member 1614, the widest width W_{M} of the medial portion 1622 is greater than the narrowest (in this case constant) width W_{P} of the respective portion 1620, measured in the common direction D. Similarly, the width W_{D} of the distal portion 1624 as measured in the common direction D will, at any given point on that distal portion 1624 be less than the widest width W_{M} of the medial portion 1622.

Each pair of adjacent locking members 1614 defines a receptacle 1644 therebetween into which a locking member 1614 of an oppositely faced interlocking sheet 1610 may be received, as shown in FIG. 17. The receptacle 1644 has inwardly directed medial projections 1646 formed by the discontinuity in width 1642 at the junction of the proximal portion 1620 and the medial portion 1622, which assists in retaining the locking members 1614 in the receptacles 1644. The interlocking sheets 1614 shown in FIG. 17 are suitable for applications where it is desirable for the separation of interlocked sheets to be more difficult.

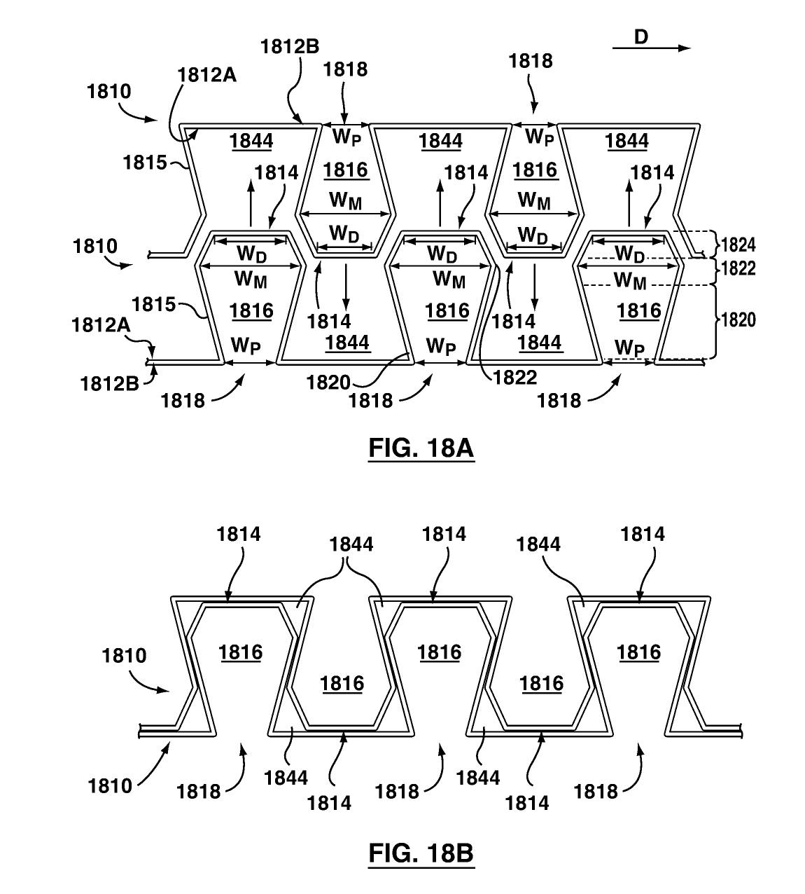

Reference is now made to FIGS. 18A and 18B, which show a pair of interlocking sheets 1810 having straight side walls 1815 according to an alternative embodiment. The interlocking sheet 1810 is formed from a resilient, flexible material and comprises a plurality of equally spaced hollow elongate linear locking members 1814 projecting from a first side 1812A of the interlocking sheet 1810. An aperture 1818 on the second side 1812B of the interlocking sheet 1810 opens into an interior volume 1816 of the locking member 1814. Each pair of adjacent locking members 1814 defines a receptacle 1844 therebetween into which a locking member 1814 of an oppositely faced interlocking sheet 1810 may be received, as shown in FIG. 18B.

Each locking member 1814 has a proximal portion 1820 adjacent the aperture 1818, a medial portion 1822 further from the aperture 1818 than the proximal portion 1820 and a distal portion 1824 further from the aperture 1818 than the medial portion 1822. For each locking member 1814, the widest width W_{M} of the respective medial portion 1822 is greater than the narrowest width W_{P} of the respective proximal portion 1820 and the width W_{D} of the distal portion 1824 will, at any given point on that distal portion 1824, be less than the widest width W_{M} of the medial portion 1822. Each locking member 1814 tapers at a constant slope from the medial portion 1822 to the distal portion 1824, and also tapers at a constant slope from the medial portion 1822 to the proximal portion 1820.

The exemplary interlocking sheets described above have included elongate linear locking members. In other embodiments, examples of which will be described below, interlocking sheets according to aspects of the present invention may comprise locking members in the form of discrete regularly spaced legs having a defined outer perimeter at the medial width.

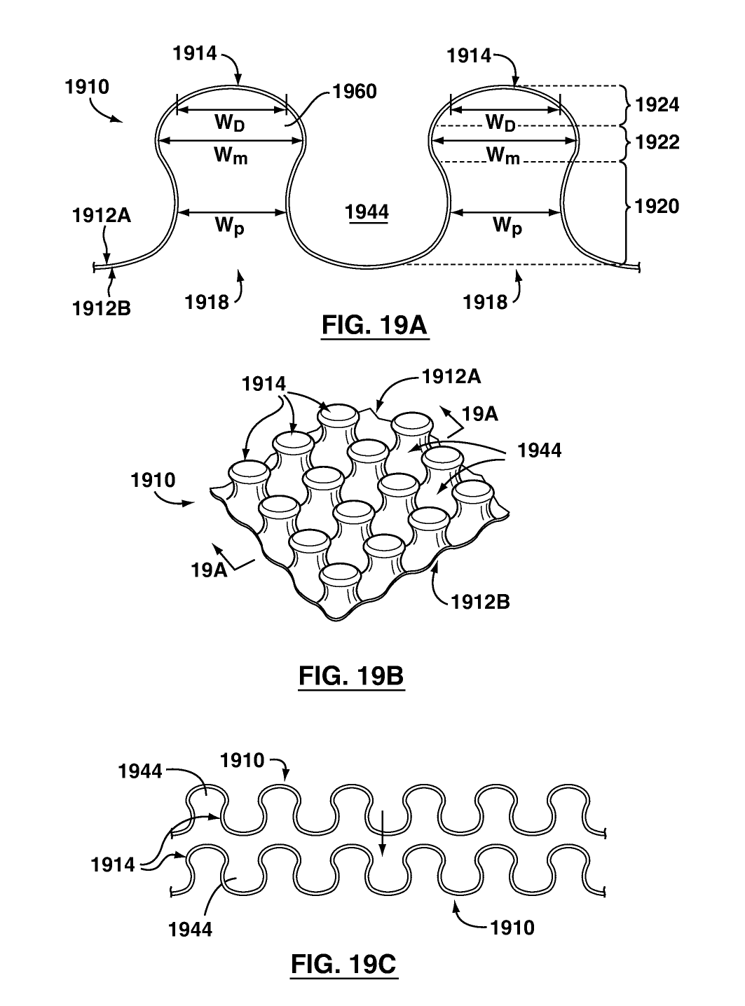

Reference is now made to FIGS. 19A to 19C, which show a first exemplary embodiment of an interlocking sheet 1910 having locking members 1914 in the form of discrete regularly spaced legs projecting from a first side 1912A of the interlocking sheet 1910. As best seen in the cross-sectional view shown in FIG. 19A, the locking members are hollow, with an aperture 1918 defined on the second side 1912B of the interlocking sheet 1910 and opening into the interior volume 1960 of the locking member 1914.

The locking members 1914 each have a proximal portion 1920 adjacent the aperture 1918 and having a narrowest width W_{P}, a medial portion 1822 further from the aperture 1918 than the proximal portion 1920 and having a widest width W_{M}, and a distal portion 1924 further from the aperture 1918 than the medial portion 1922. For each locking member 1914, the widest width W_{M} of the medial portion 1922 is greater than the narrowest width W_{P} of the proximal portion 1920 and is greater than the width W_{D} of the distal portion 1924 at any point thereon.

The locking members 1914 are generally mushroom-shaped, with the stem defined by the proximal portion 1920 and the cap defined by the medial portion 1922 and the distal portion 1924. As such, the locking members 1914 taper from the medial portion 1922 to the distal portion 1924 and from the medial portion 1922 to the proximal portion 1920. As best seen in FIG. 19B, the locking members 1914 have a circular outer perimeter at the widest medial width W_{M}, although other suitable shapes, such as a square, triangular, hexagonal or octagonal outer perimeter may also be used. It will be appreciated that a circular outer perimeter obviates difficulties associated with aligning the interlocking sheets 1900.

Continuing to refer to FIG. 19B, each group of four adjacent locking members 1914 defines a receptacle 1944 therebetween, with the contours of the receptacle 1944 being defined by the outer contours of each locking member 1914 in the group of four. As shown in FIG. 19C, a locking member 1914 of an oppositely faced second interlocking sheet 1910 is receivable in the receptacle 1944 of a first interlocking sheet 1910, where it will be retained by the four surrounding locking members 1944 of the first interlocking sheet 1910, and vice versa.

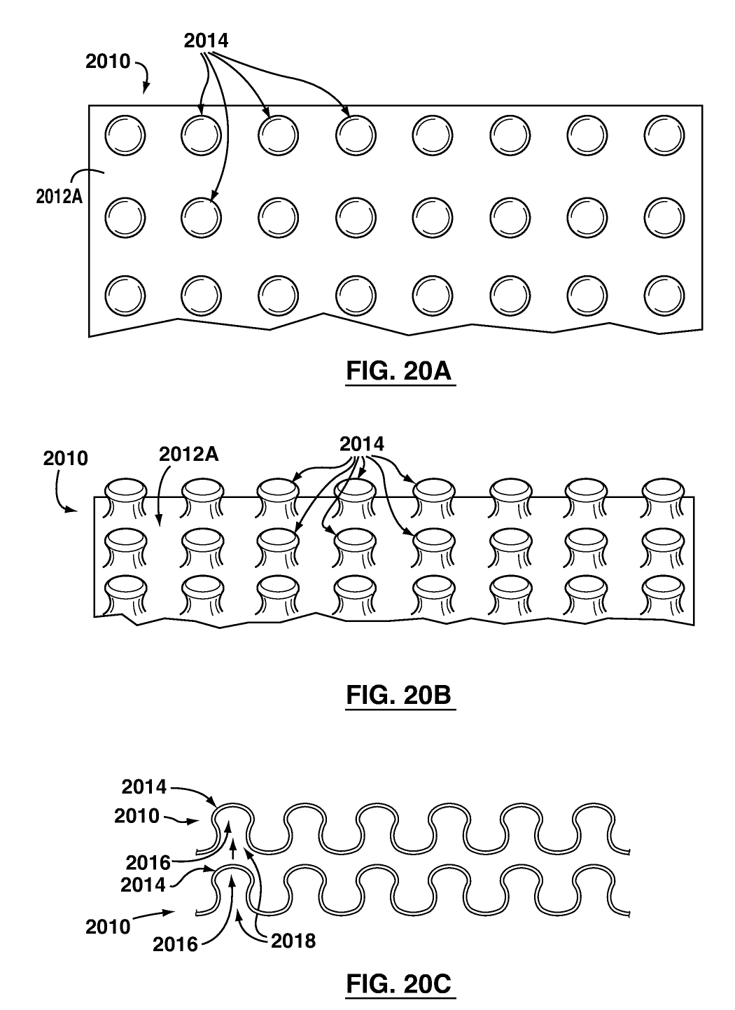

FIGS. 20A to 20C show a second exemplary embodiment of an interlocking sheet 2010 having locking members 2014 in the form of discrete regularly spaced legs projecting from a first side 2012A of the interlocking sheet 2010. The second embodiment 2010 is similar in construction to the first embodiment 1910 shown in FIGS. 19A to 19C, and corresponding reference numerals are used to denote corresponding elements, except with the prefix “20” instead of “19”. The locking members 2014 of the second embodiment 2010 are substantially identical to the locking members 1914 of the first embodiment and therefore are not described further.

Instead of being received in a receptacle defined by the outer contours of a group of locking members on an opposed interlocking sheet, as with the first exemplary embodiment 1910, in the second exemplary embodiment 2010 the aperture 2018 and interior volume 2016 cooperate to define a receptacle, and the locking members 2014 are positioned so that each locking member 2014 can be received inside another locking member 2014, as shown in FIG. 20C.

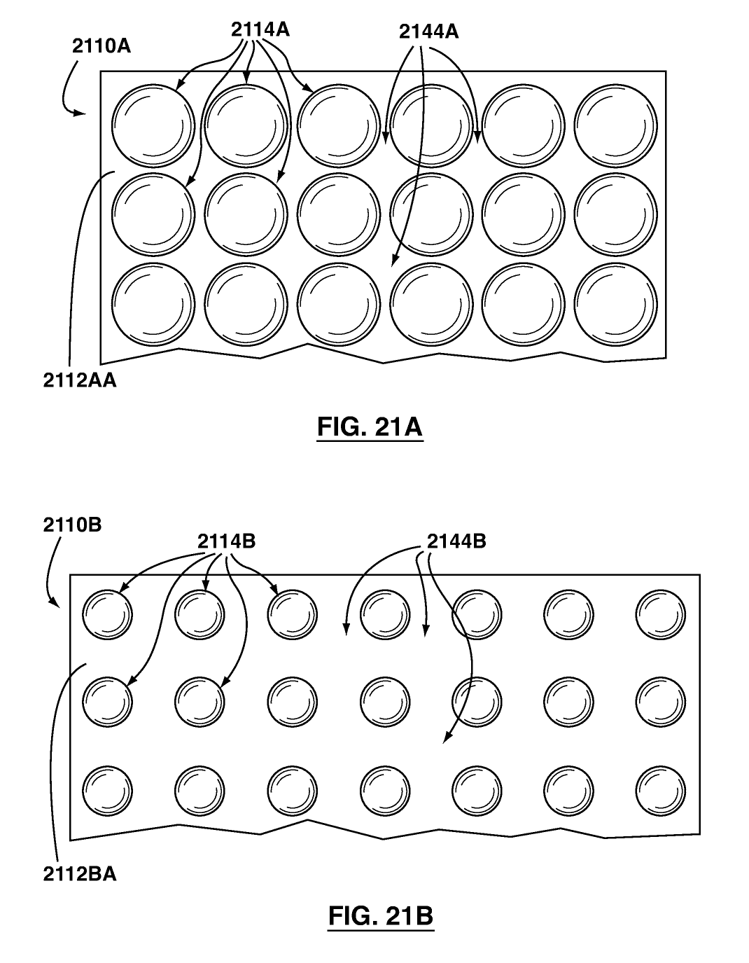

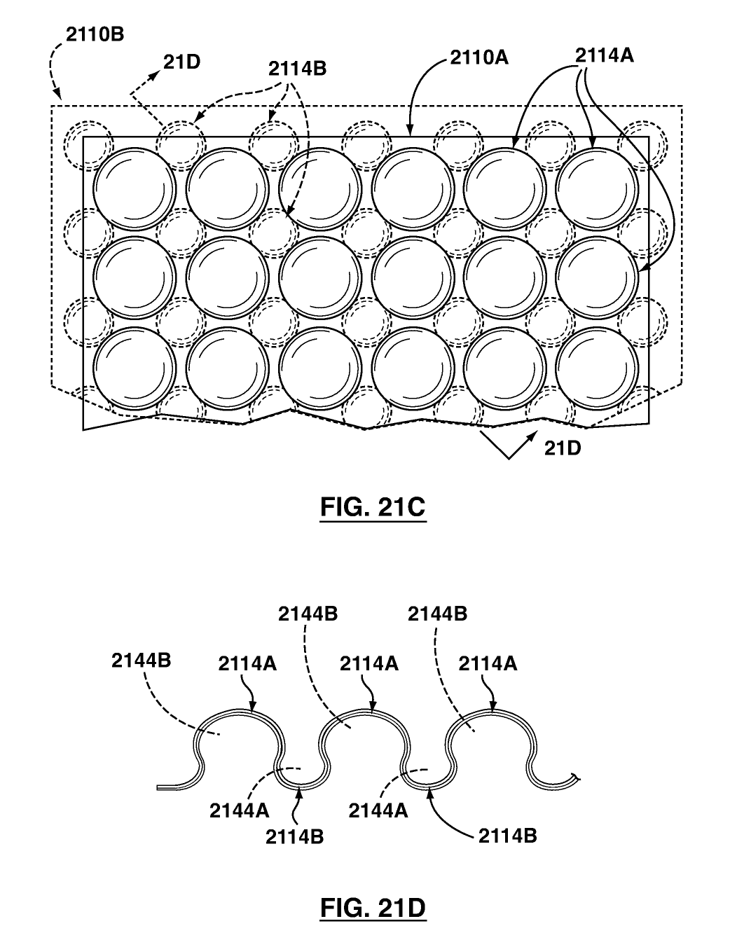

Reference is now made to FIGS. 21A to 21D, which show an embodiment comprising first and second interlocking sheets 2110A, 2110B having respective locking members 2114A, 2114B in the form of discrete regularly spaced legs projecting from a first side 2110AA, 2110BA of the respective interlocking sheet 2110A, 2110B. The first interlocking sheet 2110A is shown in FIG. 21A, and the second interlocking sheet 2110B is shown in FIG. 21B. The locking members 2114A, 2114B are substantially identical to the locking members 1914 described above, except that the locking members 2114A of the first interlocking sheet 2110A are larger than the locking members 2114B of the second interlocking sheet 2110B, with the outer surfaces of the locking members 2114A of the first interlocking sheet 2110A being closer together than the outer surfaces of the locking members 2114B of the second interlocking sheet 2110B.

Analogously to the above-described interlocking sheet 1910, for each of the interlocking sheets 2110A, 2110B, each group of four adjacent locking members 2014A, 2014B defines a respective receptacle 2044A, 2044B therebetween, with the contours of the receptacles 2044A, 2044B being defined by the outer contours of each locking member 2014A, 2014B in the respective group of four. As shown in FIGS. 21C and 21D, when the interlocking sheets 2110A, 2110B are arranged with the first sides 2110AA, 2110BA thereof facing one another, the locking members 2114A of the first interlocking sheet 2110A are receivable in the receptacles 2044B of the second interlocking sheet 2010B, and the locking members 2114B of the second interlocking sheet 2110B are receivable in the receptacles 2044A of the first interlocking sheet 2010A. Each locking member 2114A, 2114B is retained by the four surrounding locking members 2114A, 2114B of the other interlocking sheet 1910.

Various techniques may be used to produce interlocking sheets according to aspects of the present invention.

In one embodiment, as shown in FIG. 1, where the interlocking sheets include longitudinally extending locking members, the interlocking sheets may be extruded from an extruder 50 having a die 52 whose aperture 54 corresponds to the desired cross-sectional shape of the interlocking sheet, so that the interlocking sheet is extruded in a longitudinal direction parallel to the longitudinal direction in which the locking members 14 extend. In the embodiment shown in FIG. 1, an interlocking sheet 10 of the type shown in FIGS. 2 to 7A, having flat portions 12, is being extruded; interlocking sheets 1010 of the type shown in FIGS. 10 through 18 may also be extruded using the technique shown in FIG. 1; the technique shown in FIG. 1 is not suitable for the interlocking sheets shown in FIGS. 19A to 21D.

Interlocking sheets 10 will typically be wound into rolls for transportation, and as noted above should be wound about an axis extending parallel to the longitudinal direction in which the locking members 14 extend, otherwise the locking members 14 will be bent or crushed, or will interfere with the rolling process, or both. As a result, the extrusion technique shown in FIG. 1 will in practice be limited to producing rolls whose length is limited to the length of the aperture 54 of the extrusion die 52. In addition, because transportation imperatives impose practical limits on the width of the rolls, the extruded interlocking sheets 10 would have to be frequently cut, which could interfere with the efficiency of the extrusion process.

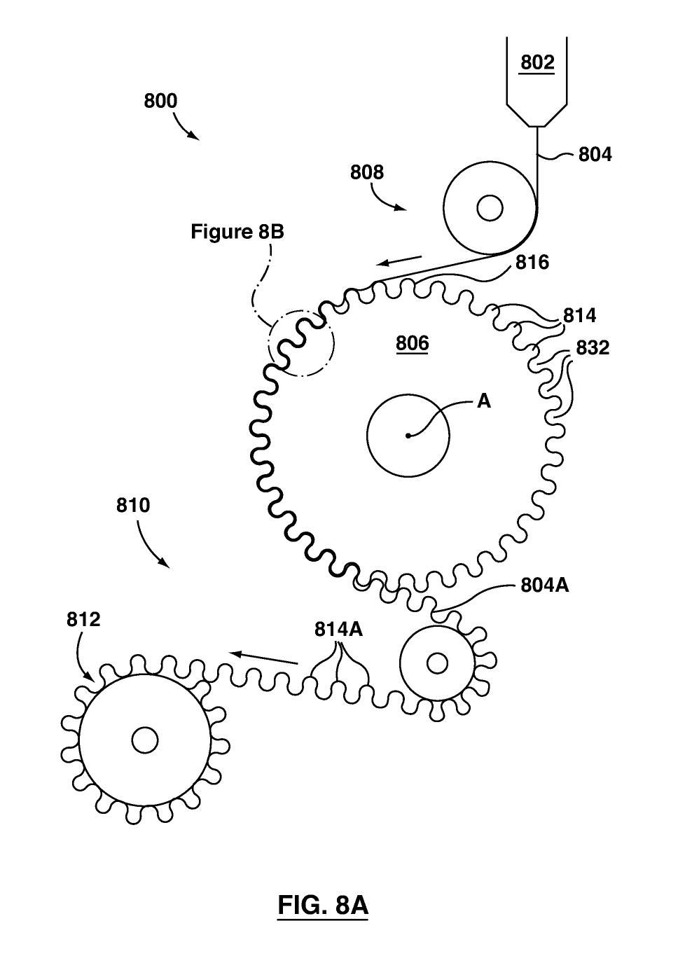

In another embodiment, as shown schematically in FIGS. 8A and 8B, interlocking sheets may be formed using specialized apparatus denoted generally by the reference numeral 800. The apparatus 800 comprises an extruder 802 for extruding a web 804, a vacuum forming roller 806, a guide mechanism 808 for guiding the web 804 into engagement with the outer surface 816 of the vacuum forming roller 806 and a winding mechanism 810 for removing the web 804 from the vacuum forming roller 806 and winding the web 804 into a roll 812. The extruder 802, guide mechanism 808 and winding mechanism 810 are conventional, and any suitable extruders and mechanisms now known or hereafter developed may be used.

As shown in FIG. 8A, and as shown in greater detail in FIG. 8B, the outer surface 816 of the vacuum forming roller 806 includes a plurality of projections 814. The projections 814 are used to form the locking members and apertures on interlocking sheets according to aspects of the present invention. In the particular exemplary embodiment shown in FIGS. 8A and 8B, the vacuum forming roller 806 is designed to form interlocking sheets having locking members of the type shown in FIGS. 10 to 14 and thus the projections 814 have a shape corresponding to those locking members. In particular, the projections 814 are elongate linear projections and extend across a width of the vacuum forming roller 806, parallel to the axis of rotation A thereof. The locking members on one side of the sheet will be formed by the projections 814, and the locking members on the other side of the sheet will be formed by the recess regions 832 between the projections 814. In other embodiments, interlocking sheets according to aspects of the present invention may have locking members with different shapes, and the apparatus 800 could be used to manufacture any of the interlocking sheets described herein by using another vacuum forming roller having appropriately shaped projections.

As best seen in FIG. 8B, the projections 814 on the vacuum forming roller 806 each have a proximal portion 820, a medial portion 822 and a distal portion 824. The medial portion 822 is further from the axis of rotation A of the vacuum forming roller 806 than the proximal portion 820, and, as measured in a common direction T tangential to a notional circle centered on the axis A of the vacuum forming roller, has a maximum width greater than the minimum width of the proximal portion 820. The distal portion 824 is further from the axis of rotation A than the medial portion 822, and is narrower in the common direction T than the widest width of the medial portion 822. The vacuum forming roller 806 has vacuum apertures 830 defined its outer surface 816. In the illustrated embodiment the vacuum apertures 830 are defined in the proximal portions 820 of the projections 814 and also in the recess regions 832 between the projections 814; additional vacuum apertures (not shown) may be defined in other portions of the projections. The vacuum apertures draw the semi-molten web 804 down over outer surface 816 of the vacuum forming roller 806 so that web 804 acquires the shape of the outer surface 816, including the projections 814, and cools in that shape, thereby forming the web 804 into an interlocking sheet 804A as shown in FIG. 8A.

The apparatus 800 enables a method of forming an interlocking sheet. In operation, the web 804 is extruded from the extruder 802 and guided by the guide mechanism 808 to the vacuum forming roller 806 while the web 804 is still in a semi-molten state. A vacuum is applied to the vacuum forming roller 806 while the web 804 is in contact with the outer surface 816 thereof so that as the web 804 cools, the web 804 acquires locking members 814A, corresponding in size, shape and position to the projections 814 on the vacuum forming roller 806, to become an interlocking sheet. Cooling of the web 804 may be achieved by ambient air cooling, blown air, active cooling in the vacuum forming roller 806, or any other suitable technique.

The web 804, now formed into an interlocking sheet 804A, then proceeds to the winding mechanism 810. The winding mechanism 810 removes the interlocking sheet 804 from the vacuum forming roller 806 by peeling the locking members 814A off of the projections 814, and then rolls the interlocking sheet 804A into a roll 812. Where the interlocking sheet 804A has elongate linear locking members 814A extending across the interlocking sheet 804A parallel to one another, as in the examples described above in respect of FIGS. 2A to 7B, in the roll 812 the locking members will preferably extend parallel to a central axis R of the roll 812, and most preferably the locking members of inner layers of the roll are nested inside the locking members of respective adjacent outer layers of the roll, as shown in FIGS. 6A to 7B.

As shown in FIG. 9, interlocking sheets 910 produced by the method and apparatus illustrated in FIGS. 8A and 8B will have a fixed width W determined by the size of the extrusion aperture, but can have any arbitrary practical length L.

Interlocking sheets according to an aspect of the present invention may be used in wide variety of applications. In addition to forming structures as described above, the interlocking sheets may be used to releasably secure one object to another. For example, pictures, utilitarian objects such as tools, system interfaces and the like may also be removably mounted to a vertical, horizontal or inclined surface by affixing one interlocking sheet (or portion thereof) to the surface and affixing a complementary interlocking sheet to the object to be mounted. In one embodiment, interlocking sheets according to aspects of the present invention may be secured to a roof, optionally forming a watertight barrier, and shingles having complementary interlocking sheet portions affixed to their underside may then be secured to the roof. This facilitates easy replacement of the shingles as required.

It will be appreciated that for clarity of illustration, not all reference numerals have been marked in all drawings. Various currently preferred embodiments have been described by way of example. It will be apparent to persons skilled in the art that a number of variations and modifications can be made without departing from the scope of the invention as defined in the claims.

What is claimed is:

1. An interlocking sheet formed from a resilient material, comprising:
a plurality of regularly spaced locking members projecting from a first side of the sheet; each locking member being hollow so as to define an interior volume thereof and having an aperture opening into the interior volume from a second side of the sheet;
each locking member having:
a proximal portion adjacent the aperture;
a medial portion further from the aperture than the proximal portion;
the medial portion having a widest width greater than a narrowest width of the proximal portion, measured in a common direction;
a distal portion further from the aperture than the medial portion;
each locking member tapering from the medial portion to the distal portion.

2. The interlocking sheet of claim 1, wherein the common direction is parallel to a notional plane defined by the aperture.

3. The interlocking sheet of claim 1, wherein the locking members also project from a second side of the sheet.

4. The interlocking sheet of claim 1, wherein each locking member tapers at a constant slope from the medial portion to the distal portion.

5. The interlocking sheet of claim 1, wherein each locking member tapers at a variable slope from the medial portion to the distal portion.

6. The interlocking sheet of claim 1, wherein each locking member further comprises a terminal nub further from the aperture than the distal portion.

7. The interlocking sheet of claim 1, wherein each locking member tapers at a constant slope from the medial portion to the proximal portion.

8. The interlocking sheet of claim 1, wherein each locking member tapers at a variable slope from the medial portion to the proximal portion.

9. The interlocking sheet of claim 1, wherein there is an abrupt discontinuity in width between the proximal portion and the medial portion.

10. The interlocking sheet of claim 1, wherein the locking members are elongate linear locking members and extend across the sheet parallel to one another.

11. The interlocking sheet of claim 1, wherein the locking members are discrete regularly spaced legs having a defined outer perimeter at the medial width.

12. The interlocking sheet of claim 11, wherein the legs have a circular outer perimeter at the medial width.

13. The interlocking sheet of claim 1, wherein the aperture and the interior volume of each locking member cooperate to define a receptacle for another correspondingly-shaped locking member.

14. A method of forming an interlocking sheet, comprising:
extruding a web from an extruder;
guiding the web while still semi-molten to a forming roller;
the forming roller having an outer surface including a plurality of regularly spaced projections;
the projections on the forming roller having:
a proximal portion;
a medial portion further from an axis of rotation of the forming roller than the proximal portion;
the medial portion having a widest width greater than a narrowest width of the proximal portion, measured in a common direction tangential to the forming roller;
a distal portion further from the axis of rotation of the forming roller than the medial portion;
the projections on the forming roller tapering from the medial portion to the distal portion;
the forming roller being a vacuum forming roller having vacuum apertures defined in the outer surface thereof, the vacuum apertures being defined at least in the proximal portions of the projections;
applying a vacuum to the forming roller while the web is in contact with the outer surface thereof so that the web acquires locking members corresponding in size, shape and position to the projections on the forming roller to become an interlocking sheet.

15. The method of claim 14, wherein the forming roller is actively cooled to cool the web.

16. The method of claim 14, wherein the projections are elongate linear projections and extend across a width of the forming roller, parallel to an axis of rotation thereof.

17. A method according to claim 16, further comprising:
removing the interlocking sheet from the forming roller, the interlocking sheet having elongate linear locking members extending across the sheet parallel to one another; and
rolling the interlocking sheet into a roll in which the locking members extend parallel to a central axis of the roll.

18. The method of claim 17, wherein rolling the interlocking sheet into a roll comprises rolling the interlocking sheet into a roll in which the locking members of inner layers of the roll are nested inside respective locking members of adjacent outer layers of the roll.

19. Apparatus for forming an interlocking sheet, comprising:
a forming roller having an outer surface including a plurality of regularly spaced projections;
the projections on the forming roller having:
a proximal portion;
a medial portion further from an axis of rotation of the forming roller than the proximal portion;
the medial portion having a widest width greater than a narrowest width of the proximal portion, measured in a common direction tangential to the forming roller;
a distal portion further from the axis of rotation of the forming roller than the medial portion;
the projections on the forming roller tapering from the medial portion to the distal portion;
the forming roller being a vacuum forming roller having vacuum apertures defined in the outer surface thereof, the vacuum apertures being defined at least in the proximal portions of the projections.

20. The apparatus of claim 18, further comprising:
an extruder for extruding a web; and
a guide mechanism for guiding the web into engagement with the outer surface of the vacuum forming roller.

21. The apparatus of claim 19, further comprising:
a winding mechanism for removing the web from the vacuum forming roller and winding the web into a roll.
